(19) United States
(12) Patent Application Publication
(10) Pub. No.: US 2014/0326935 A1
(43) Pub. Date: Nov. 6, 2014

(54) Ratcheting Load Binder with Enclosed Ratchet Mechanism

(71) Applicant: James Chuan CHAO, Potomac, MD (US)

(72) Inventor: James Chuan CHAO, Potomac, MD (US)

(21) Appl. No.: 13/887,468

(22) Filed: May 6, 2013

(51) Int. Cl. B60P 7/08; F16G 11/12

(52) U.S. Cl. CPC B60P 7/083; F16G 11/12
USPC 254/235

(57) ABSTRACT

A ratcheting load binder with enclosed ratchet mechanism has an elongated tubular body, a handle, a ratcheting mechanism, and two threaded shafts. The handle is engaged with the tubular body by the ratcheting mechanism, and is perpendicular to the tubular body. A ratchet gear and ratchet pawl of the ratcheting mechanism are enclosed within a housing of the handle. The ratchet pawl is engaged and disengaged from the ratchet gear by turning a ratchet lever outside the housing. The tubular body has internal threads at its extremities that are of opposing handedness. The threaded shafts are engaged with the internal threads within the elongated tubular body. Turning the tubular body by using the handle causes the threaded shafts to move in opposing directions, allowing a chain to be tightened or loosened between two locations by ratcheting the tubular body with the handle. The handle may also be folded for storage.

The current application claims a priority to the U.S. Nonprovisional patent application Ser. No. 13/769,427 filed on Feb. 18, 2013.

### FIELD OF THE INVENTION

The present invention relates generally to securing cargo for transport. More particularly, the present invention relates to an improved ratcheting load binder.

### BACKGROUND OF THE INVENTION

Cargo, or freight, is good or produce transported, generally for commercial gain, by ship, aircraft, train, van or truck. The trucking industry involves the transport and distribution of commercial and industrial goods using commercial motor vehicles, which are most often trucks such as semi trucks, box trucks, or dump trucks. The trucking industry in America provides an essential service to the American economy by transporting large quantities of raw materials, works in proves and finished goods over land—typically from manufacturing plants to retail distribution centers. Trucks in America are responsible for the majority of freight movement over land, and are vital tools in the manufacturing, transportation, and warehousing industries.

Particularly with flatbed trucks, securing cargo for transport is of great concern. Cargo being transported by truck is generally bulky and heavy, and particular care must be taken in loading and securing the cargo so that it does not fall off the truck and cause damage or personal injury. It has long been common to secure a load with chains that are wrapped around the load and secured to the bed of the truck. In order to ensure proper security of the load, load binders are used to tighten chains around the load as much as possible. A load binder has opposing ends with hooks that are hooked into two spaced apart chain links of the chain. The load binder has a mechanism that is used to draw the hooks together to tighten the chain. A type of load binder that is commonly in use is a ratchet binder, which has a tubular body with threaded internal ends, and threaded shafts on either end that move in and out of the tube due to rotation of the tube relative to the threaded shafts. Turning of the tube is achieved by a ratchet mechanism (pawl and ratchet gear) operated by a handle. The handle is worked back and forth to turn the tube relative to the shafts which draws the shafts into the tube and therefore achieves tightening of the chain.

One problem with current ratchet binders is that the ratchet mechanism is exposed to the environment and may become fouled with dirt and grime, requiring frequent cleanings and possibly presenting unsafe situations. In addition, a ratchet binder is awkward to store as the handle protrudes from the tube at a right angle and requires storage in a storage space that is the length of the tube and the width of the tube plus the handle length. It is therefore an object of the present invention to provide a ratchet binder with an enclosed ratchet mechanism and a folding handle.

### BRIEF DESCRIPTION OF THE DRAWINGS

FIG. 1 is a front view of the present invention.

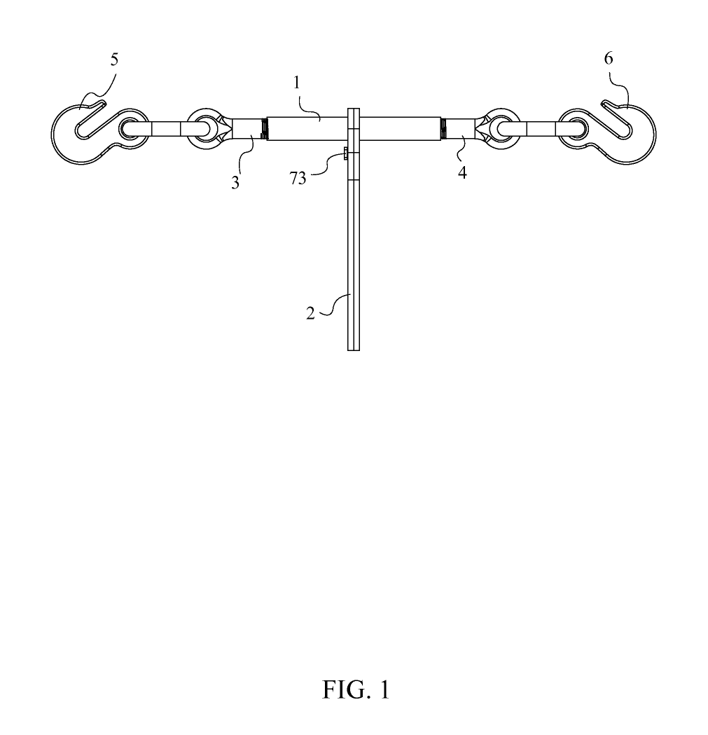

FIG. 2 is a perspective exploded view of the present invention showing the internal threads on the elongated tubular body and the ratchet gear.

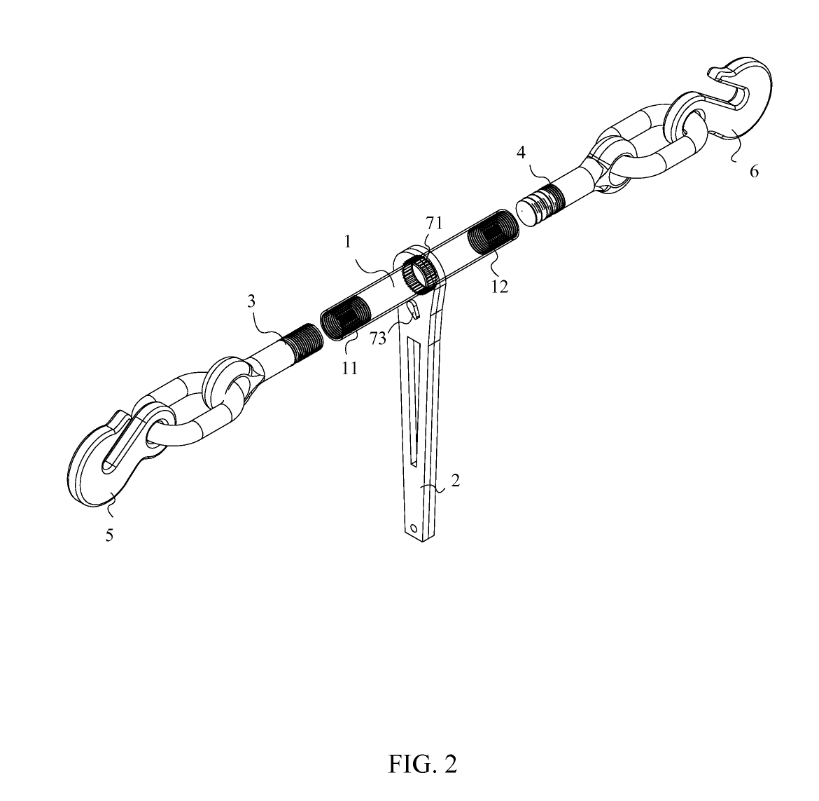

FIG. 3 is a side view of only the handle, the elongated tubular body and the ratcheting mechanism showing hidden lines depicting the components of the ratcheting mechanism.

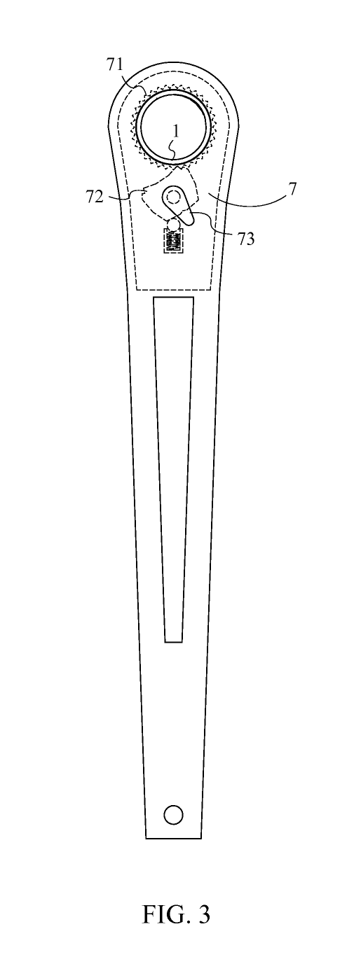

FIG. 4 is a perspective view section view of the handle showing the ratcheting mechanism within the internet ratchet compartment.

FIG. 5 is a perspective view of another embodiment of the present invention with a folding handle.

FIG. 6 is a perspective view of the folding handle embodiment of the present invention with the handle in the folded position.

### DETAIL DESCRIPTIONS OF THE INVENTION

All illustrations of the drawings are for the purpose of describing selected versions of the present invention and are not intended to limit the scope of the present invention.

The present invention is a ratcheting load binder with an enclosed ratcheting mechanism and a folding handle. The present invention improves upon prior art by enclosing the ratcheting mechanism so that the ratcheting mechanism is not fouled by dirt and grime. The present invention comprises an elongated tubular body 1, a handle 2, a first threaded shaft 3, a second threaded shaft 4, a first attachment member 5, a second attachment member 6, and a ratcheting mechanism 7. The handle 2 comprises a housing 21, an internal ratchet compartment 22, a tube aperture 23, and a folding handle portion 24. The ratcheting mechanism 7 is enclosed within the handle 2, and the handle 2 is engaged with the elongated tubular body 1 by the ratcheting mechanism 7. The handle 2 is used to rotate the elongated tubular body 1 by use of the ratcheting mechanism 7. In the preferred embodiment of the present invention, all components are made from rolled or forged steel. In alternate embodiments, the various components of the present invention may be made from alternate materials that are sufficient for withstanding significant stresses related to transporting cargo.

The ratcheting mechanism 7 comprises a ratchet gear 71, a ratchet pawl 72, and a pawl lever 73. The ratcheting mechanism 7 may alternatively be of any embodiment, previously known or new, that allows the elongated tubular body 1 to be ratchetingly rotated by the handle 2 while having the ratcheting mechanism 7 enclosed within the handle 2. The ratchet pawl 72 engages with the ratchet gear 71, allowing rotation in one direction but prohibiting rotation in the opposite direction. The ratchet pawl 72 may be disengaged from the ratchet gear 71 to allow free spin, and may be engaged with the ratchet gear 71 in opposite orientations to allow ratcheting in both clockwise and counterclockwise directions.

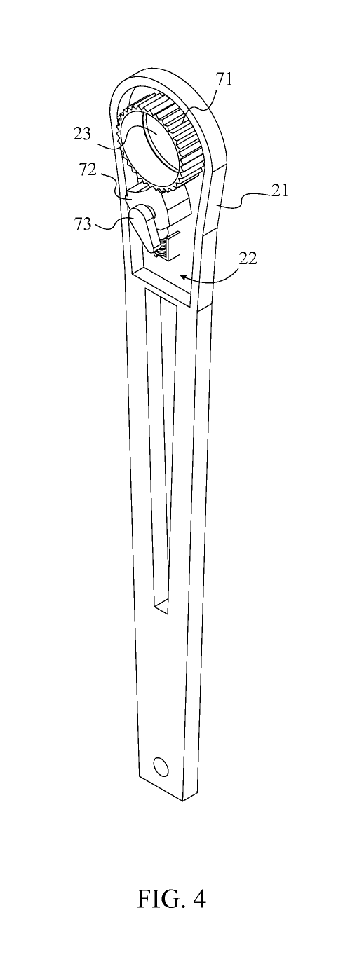

Referring to FIG. 4, the internal ratchet compartment 22 is a cavity within the housing 21 around the elongated tubular body 1 which houses the ratcheting mechanism 7. The ratchet gear 71 and the ratchet pawl 72 are positioned within the internal ratchet compartment 22, so that dirt and grime do not foul the ratcheting mechanism 7 while in use or in storage. The ratchet gear 71 is concentrically positioned with and connected to the elongated tubular body 1, and encircles the elongated tubular body 1. The ratchet gear 71 does not move relative to the elongated tubular body 1. The ratchet gear 71 may embody any appropriate number, shape and orientation of ratchet teeth. The pawl lever 73 is positioned outside of the handle 2, adjacent to the housing 21 opposite the internal ratchet compartment 22. The pawl lever 73 is axially connected to the ratchet pawl 72 through the housing 21 by a pawl rod, so that turning the pawl lever 73 turns the ratchet pawl 72 the same amount as the pawl lever 73. The pawl lever 73 is used to turn the ratchet pawl 72 in order to engage or disengage the ratchet pawl 72 from the ratchet gear 71.

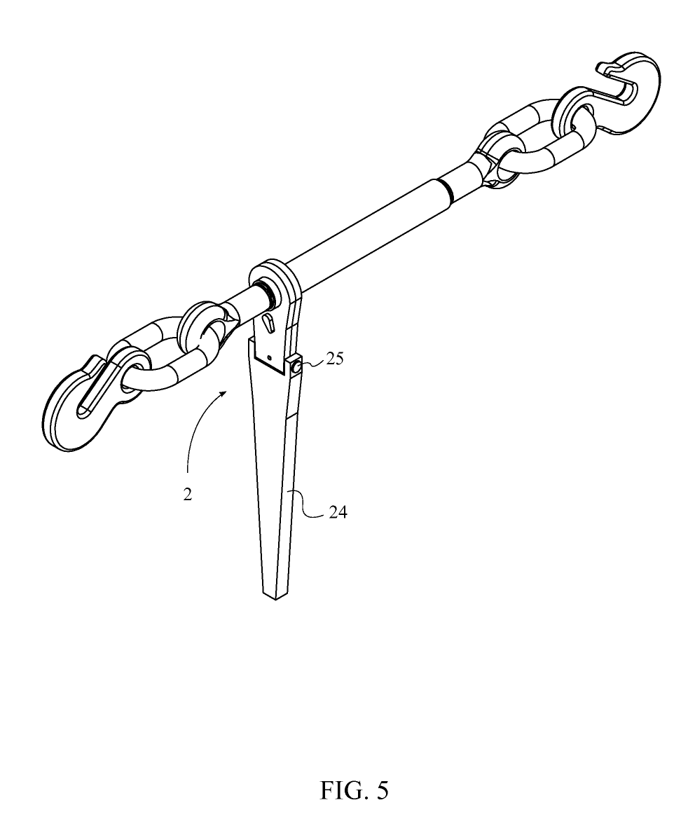

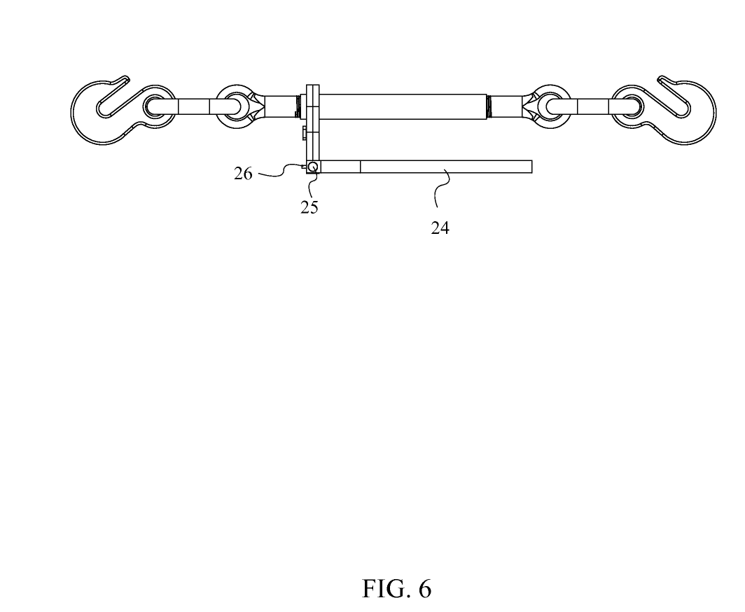

The tube aperture 23 traverses through the housing 21, and the elongated tubular body 1 is concentrically positioned within the tube aperture 23. Referring to FIGS. 5 and 6, the folding handle portion 24 is rotatably connected to the housing 21 by a hinge 25, and a rotation axis of the hinge 25 is oriented perpendicularly to the elongated tubular body 1. The folding handle portion 24 may preferably be in one of two orientations: perpendicular to the elongated tubular body 1, and parallel to the elongated tubular body 1. In the preferred embodiment of the present invention, the folding handle portion 24 is held in one of the two orientations by a pin 26. Additionally, the folding handle portion 24 is preferably limited to 90 degrees of rotation between the two orientations. In an alternate embodiment, the handle 2 does not comprise the folding handle portion 24, or may comprise a different orientation or folding means, or may be detached completely.

The elongated tubular body 1 comprises a first internal thread 11 and a second internal thread 12. The first internal thread 11 and the second internal thread 12 are positioned axially opposite from each other along the elongated tubular body 1 at extremities of the elongated tubular body 1. The first threaded shaft 3 and the second threaded shaft 4 are concentrically positioned within the elongated tubular body 1. The first threaded shaft 3 is rotatably engaged with the elongated tubular body 1 by the first internal thread 11, and the second threaded shaft 4 is rotatably engaged with the elongated tubular body 1 by the second internal thread 12. The first internal thread 11 spirals in a first helical direction, and the second internal thread 12 spirals in a second helical direction, wherein the second helical direction is the opposite of the first helical direction. Therefore, rotating the elongated tubular body 1 relative to the first threaded shaft 3 and the second threaded shaft 4 results in the first threaded shaft 3 and the second threaded shaft 4 moving in opposite directions axially along the elongated tubular body 1.

The first attachment member 5 and the second attachment member 6 are from a group consisting of eyelets, hooks, pelican hooks, jaws, and stub ends. The first attachment member 5 is connected to the first threaded shaft 3 opposite the elongated tubular body 1. In one embodiment, the first attachment member 5 is connected to the first threaded shaft 3 by one or more chain links. In another embodiment, the first attachment member 5 and the first threaded shaft 3 are both parts of a singular component. Similarly, the second attachment member 6 is connected to the second threaded shaft 4 opposite the elongated tubular body 1. In one embodiment, the second attachment member 6 is connected to the second threaded shaft 4 by one or more chain links. In another embodiment, the second attachment member 6 and the second threaded shaft 4 are both parts of a singular component. The first attachment member 5 does not substantially rotate relative to the first threaded shaft 3, and the second attachment member 6 does not substantially rotate relative to the second threaded shaft 4.

To use the present invention, a user connects the first attachment member 5 and the second attachment member 6 to locations that are to be drawn together, such as links in a chain. The user places the handle 2 in the orientation perpendicular to the elongated cylindrical body and engages the ratchet pawl 72 with the ratchet gear 71 in the position for uptake, or for drawing the first threaded shaft 3 and the second threaded shaft 4 toward each other within the elongated tubular body 1. The user then works the handle 2 back and forth, ratchetingly rotating the elongated tubular body 1 relative to the first threaded shaft 3 and the second threaded shaft 4, and causing the first threaded shaft 3 and the second threaded shaft 4 to be drawn towards each other due to the opposing helical directions of the first internal thread 11 and the second internal thread 12. This action tightens a chain the first attachment member 5 and the second attachment member 6 are attached to. To loosen the chain, the user simply performs the opposite action.

Although the invention has been explained in relation to its preferred embodiment, it is to be understood that many other possible modifications and variations can be made without departing from the spirit and scope of the invention as hereinafter claimed.

What is claimed is:

1. A ratcheting load binder with enclosed ratchet mechanism comprises:
an elongated tubular body;
a handle;
a first threaded shaft;
a second threaded shaft;
a first attachment member;
a second attachment member;
a ratcheting mechanism;
the handle comprises a housing, an internal ratchet compartment, a tube aperture, and a folding handle portion;
the ratcheting mechanism being enclosed within the handle;
the handle being engaged with the elongated tubular body by the ratcheting mechanism, wherein the handle is used to rotate the elongated tubular body by the ratcheting mechanism;

2. The ratcheting load binder with enclosed ratchet mechanism as claimed in claim 1 comprises:
the ratcheting mechanism comprises a ratchet gear, a ratchet pawl, and a pawl lever;
the ratchet gear and the ratchet pawl being positioned within the internal ratchet compartment;
the ratchet gear being concentrically positioned with the elongated tubular body;
the ratchet gear being connected to the tubular body;
the ratchet gear encircling the elongated tubular body;
the pawl lever being positioned adjacent to the housing opposite the internal ratchet compartment;
the pawl lever being axially connected to the pawl;
the ratchet pawl being removably engaged with the ratchet gear, wherein the pawl lever is used to engage and disengage the ratchet pawl with the ratchet gear;

3. The ratcheting load binder with enclosed ratchet mechanism as claimed in claim 1 comprises:
the internal ratchet compartment being positioned within the housing;
the tube aperture traversing through the housing;
the elongated tubular body being concentrically positioned within the tube aperture;
the folding handle portion being rotatably connected to the housing by a hinge;
a rotation axis of the hinge being oriented perpendicularly to the elongated tubular body;

4. The ratcheting load binder with enclosed ratchet mechanism as claimed in claim 1 comprises:
the first threaded shaft and the second threaded shaft being concentrically positioned within the elongated tubular body;
the first attachment member being connected to the first threaded shaft opposite the elongated tubular body, wherein the first attachment member does not rotate relative to the first threaded shaft;
the second attachment member being connected to the second threaded shaft opposite the elongated tubular body, wherein the second attachment member does not rotate relative to the second threaded shaft;

5. The ratcheting load binder with enclosed ratchet mechanism as claimed in claim 1 comprises:
the elongated tubular body comprises a first internal thread and a second internal thread;
the first internal thread and the second internal thread being concentrically positioned within the elongated tubular body;
the first internal thread and the second internal thread being positioned axially opposite from each other along the elongated tubular body;
the first threaded shaft being rotatably engaged with the elongated tubular body by the first internal thread;
the second threaded shaft being rotatably engaged with the elongated tubular body by the second internal thread;

6. The ratcheting load binder with enclosed ratchet mechanism as claimed in claim 5 comprises:
the first internal thread spiraling in a first helical direction;
the second internal thread spiraling in a second helical direction, wherein the second helical direction is the opposite of the first helical direction;
wherein rotating the elongated tubular body relative to the first threaded shaft and the second threaded shaft results in the first threaded shaft and the second threaded shaft moving in opposite directions axially along the elongated tubular body;
